(19) United States
(12) Patent Application Publication
(10) Pub. No.: US 2009/0316435 A1
(43) Pub. Date: Dec. 24, 2009

(54) ELECTRONIC DEVICE AND DECORATION ELEMENT THEREOF

(75) Inventors: Chi-Feng Li, Taipei (TW); Wen-Te Chuang, Taipei (TW); Kyi-Lain Lee, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., TAIPEI CITY (TW)

(21) Appl. No.: 12/359,100

(22) Filed: Jan. 23, 2009

(30) Foreign Application Priority Data
Jun. 20, 2008 (TW) TW97123019

(51) Int. Cl. F21V 7/04

(52) U.S. Cl. 362/625

(57) ABSTRACT

An electronic device is provided. The electronic device comprises a housing, a light source and a decoration element. The light source is disposed in the housing to provide a light beam. The decoration element is embedded in the housing and partially exposed on an outer surface of the housing. The decoration element comprises a light entering surface, a reflective surface, a light emitting surface and a plurality of meshed spots. A light beam enters the light guide through the light entering surface, is reflected by the meshed spots, and exits the light guide through the light emitting surface.

### CROSS REFERENCE TO RELATED APPLICATIONS

This Application claims priority of Taiwan Patent Application No. 097123019, filed on Jun. 20, 2008, the entirety of which is incorporated by reference herein.

### BACKGROUND OF THE INVENTION

1. Field of the Invention

The present invention relates to a decoration element, and in particular relates to a decoration element disposed on a surface of an electronic device to provide an illuminated impression.

2. Description of the Related Art

FIG. 1 shows a conventional decoration element 10 and conventional light sources 20. Conventionally, the light sources 20 are disposed below the decoration element 10 providing light beams to the decoration element 10 to produce an illuminated impression. The light sources 20 provide light beams to the decoration element 10 via a direct-type illumination impression. Therefore, a large number of light sources 20 are required and are uniformly distributed to provide uniform illuminated impression to prevent black bands from being displayed or prevent non-uniform illumination impressions. However, a large number of light sources 20 generate great heat, consume more energy and increase costs. Additionally, the conventional direct-type illuminated impression has high brightness and sharp impressions, which may be uncomfortable for the human eyes.

### BRIEF SUMMARY OF THE INVENTION

A detailed description is given in the following embodiments with reference to the accompanying drawings.

An electronic device is provided. The electronic device comprises a housing, a light source and a decoration element. The light source is disposed in the housing to provide a light beam. The decoration element is embedded in the housing and partially exposed on an outer surface of the housing. The decoration element comprises a light entering surface, a reflective surface, a light emitting surface and a plurality of meshed spots. A light beam enters the light guide through the light entering surface, is reflected by the meshed spots, and exits the light guide through the light emitting surface.

The embodiment of the invention utilizes only one single light emitting diode as light source to provide a uniform illuminated impression. The light source of the embodiment generates less heat, consumes less energy and decreases costs. Additionally, the embodiment utilizes a side-type illumination impression, which has softer impression, and is more comfortable for the human eyes.

### BRIEF DESCRIPTION OF THE DRAWINGS

The present invention can be more fully understood by reading the subsequent detailed description and examples with references made to the accompanying drawings, wherein:

FIG. 1 shows a conventional decoration element and conventional light sources;

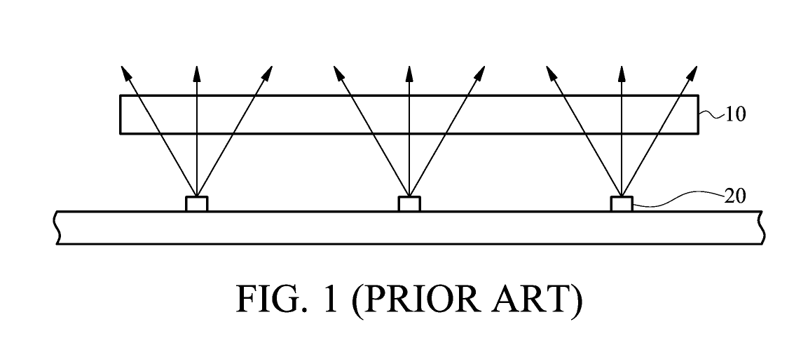

FIG. 2a is a perspective view of a decoration element of an embodiment of the invention;

FIG. 2b is a side view of the decoration element of the embodiment of the invention;

FIG. 3 shows the decoration element of the embodiment of the invention disposed in an electronic device of the embodiment; and

FIG. 4 is an enlarged view of portion A of FIG. 3.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

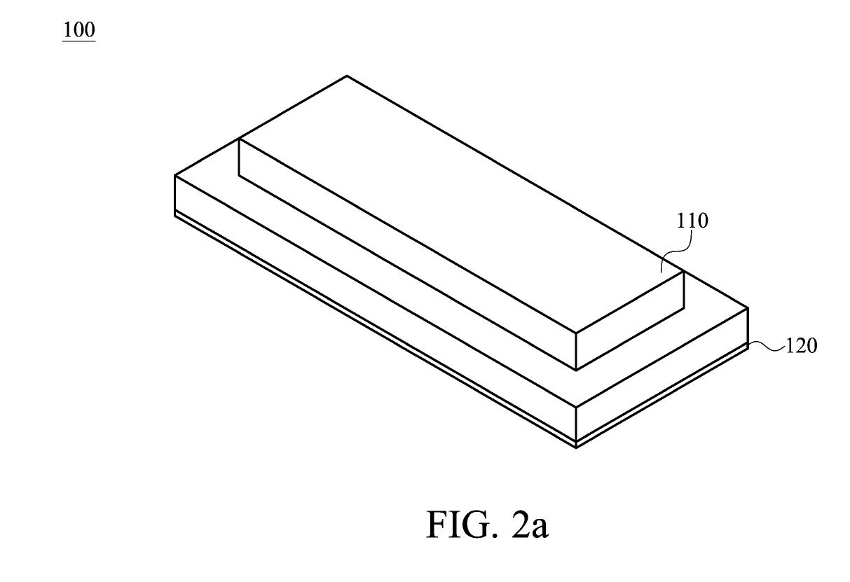

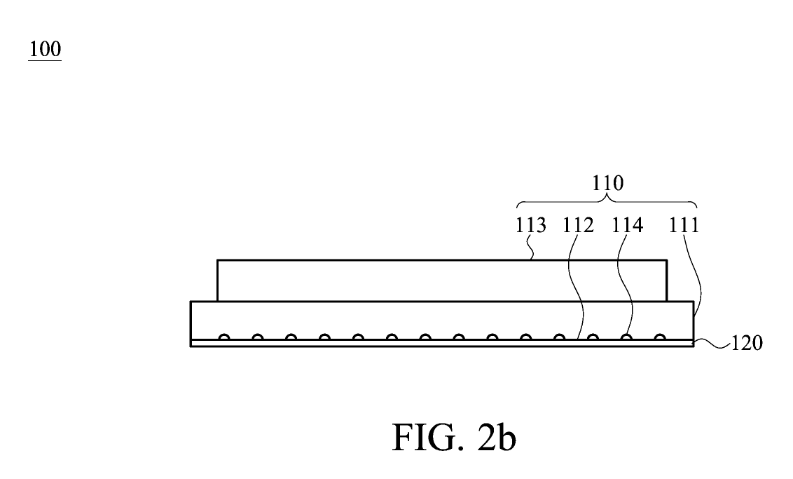

FIGS. 2a and 2b show a decoration element 100 of an embodiment of the invention, which is disposed on a surface of an electronic element to provide an illuminated impression. The decoration element 100 comprises a light guide 110 and a reflector 120. The light guide 110 comprises a light entering surface 111, a reflective surface 112, a light emitting surface 113 and a plurality of meshed spots 114. The reflector 120 is disposed on the reflective surface 112. The reflective surface 112 is parallel to the light emitting surface 113. The light entering surface 111 is perpendicular to the reflective surface 112.

In one embodiment, the reflector 120 is white.

In one embodiment, the reflector 120 is made of adhesive paper.

A cross-section of the light guide 110 is T shaped. The light guide 110 wedges a housing of the electronic device. In a modified embodiment, the light guide 110 can be planar, or a cross-section of the light guide can be ladder shaped or other shapes.

The light guide 110 can be transparent or colored, for example, green, red, blue, purple, yellow or white.

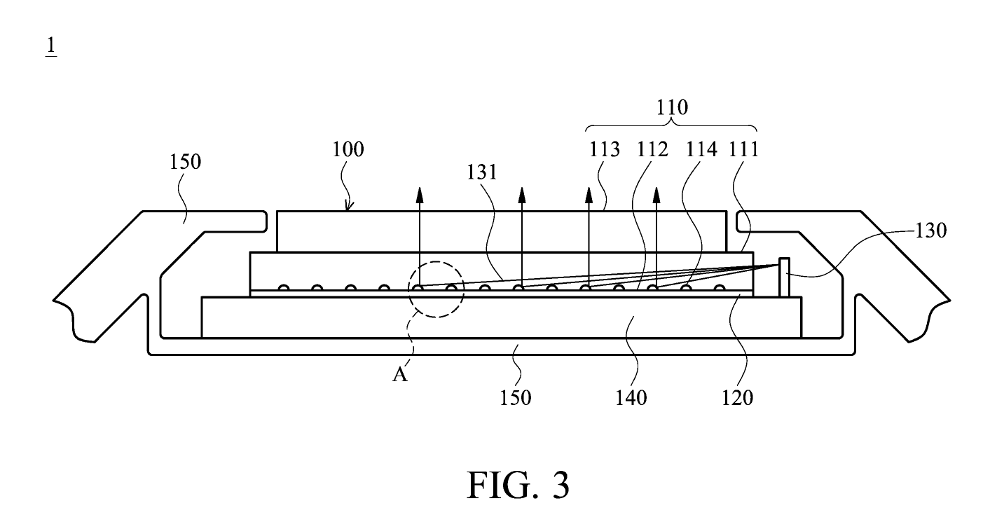

FIG. 3 shows the decoration element 100 of the embodiment of the invention disposed in an electronic device 1 of the embodiment. The electronic device comprises the decoration element 100, a light source 130, a print circuit board 140 and a housing 150. The light source 130 is disposed on the print circuit board 140. The light source 130 and the print circuit board 140 are disposed in the housing 150. The decoration element 110 is partially embedded in the housing 150, and the light emitting surface 113 is exposed on an outer surface of the housing 150.

When the illuminated impression is provided, a light beam 131 is emitted from the light source 130, entering the light guide 110 through the light entering surface 111, reflected by the meshed spots 114 and the reflector 120, and exits the light guide 110 through the light emitting surface 113.

In the embodiment of the invention, the light source 130 is a light emitting diode. The light source 130 can be colored or white. In the embodiment, a colored light source 130 can be arranged with a transparent light guide 110, or a white light source 130 can be can be arranged with a colored light guide 110.

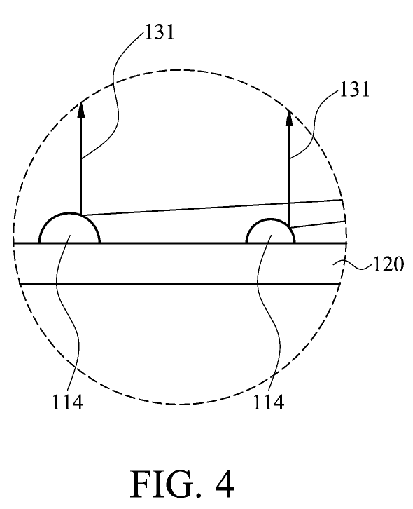

FIG. 4 is an enlarged view of portion A of FIG. 3, wherein the meshed spots 114 are semicircular protrusions. The heights of the meshed spots 114 change gradually with the distances between the meshed spots 114 and the light entering surface 111 to sufficiently reflect light beam 131. In a modified embodiment, the meshed spots 114 can be triangular taper or in other shapes.

The embodiment of the invention utilizes only one single light emitting diode as light source to provide uniform illuminated impression. The light source of the embodiment generates less heat, consumes less energy and decreases costs. Additionally, the embodiment utilizes a side-type illumination impression, which has softer impression, and is more comfortable for the human eyes.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A decoration element, disposed on a surface of an electronic device to provide an illuminated impression, comprising:
a light guide, comprising a light entering surface, a reflective surface, a light emitting surface and a plurality of meshed spots, wherein a light beam enters the light guide through the light entering surface, is reflected by the meshed spots, and exits the light guide through the light emitting surface.

2. The decoration element as claimed in claim 1, further comprising a reflector, disposed on the reflective surface to reflect the light beam.

3. The decoration element as claimed in claim 2, wherein the reflector is white.

4. The decoration element as claimed in claim 2, wherein the reflector is made of adhesive paper.

5. The decoration element as claimed in claim 1, wherein a cross-section of the light guide is T shaped.

6. The decoration element as claimed in claim 1, wherein the reflective surface is parallel to the light emitting surface, and the light entering surface is perpendicular to the reflective surface.

7. The decoration element as claimed in claim 1, wherein the light guide is colored.

8. The decoration element as claimed in claim 1, wherein the meshed spots are semicircular protrusions.

9. An electronic device, comprising:
a housing;
a light source, disposed in the housing to provide a light beam; and
a decoration element, embedded in the housing and partially exposed on an outer surface of the housing, wherein the decoration element comprises a light entering surface, a reflective surface, a light emitting surface and a plurality of meshed spots, and a light beam enters the light guide through the light entering surface, is reflected by the meshed spots, and exits the light guide through the light emitting surface.

10. The electronic device as claimed in claim 9, wherein the decoration element further comprises a reflector, disposed on the reflective surface to reflect the light beam.

11. The electronic device as claimed in claim 10, wherein the reflector is white.

12. The electronic device as claimed in claim 10, wherein the reflector is made of adhesive paper.

13. The electronic device as claimed in claim 9, wherein a cross-section of the light guide is T shaped.

14. The electronic device as claimed in claim 9, wherein the reflective surface is parallel to the light emitting surface, and the light entering surface is perpendicular to the reflective surface.

15. The electronic device as claimed in claim 9, wherein the light guide is colored.

16. The electronic device as claimed in claim 9, wherein the light source is light emitting diode.

17. The electronic device as claimed in claim 9, wherein the electronic device is a portable electronic device or a notebook.

18. The electronic device as claimed in claim 9, wherein the meshed spots are semicircular protrusions.
